(19) United States
(12) Patent Application Publication
(10) Pub. No.: US 2014/0324217 A1
(43) Pub. Date: Oct. 30, 2014

(54) Fuel Island Redundant Monitoring System

(71) Applicant: R. Keith Barker, Walhalla, SC (US)

(72) Inventor: R. Keith Barker, Walhalla, SC (US)

(21) Appl. No.: 14/264,798

(22) Filed: Apr. 29, 2014

Related U.S. Application Data
(60) Provisional application No. 61/854,734, filed on Apr. 30, 2013.

(51) Int. Cl. B67D 7/22

(52) U.S. Cl. CPC B67D 7/222
USPC 700/244

(57) ABSTRACT

A fuel island redundant monitoring system having sensors of varying purpose to transmit data signals to dual remote monitoring stations. One monitoring site is a live monitoring station manned by personnel. The other monitoring station is a data receiving station utilizing unmanned machines, e.g., computers. The unmanned data station is capable of transmitting information to the manned monitoring station, to local fuel island managers and/or to local emergency responders, and/or to control equipment at the fuel island. The manned monitoring station is capable of transmitting commands or inquiries to the unmanned data station and/or to control equipment at the fuel island, and/or to local fuel island managers and/or to local emergency responders. Sensors may be dedicated to either the unmanned data station or the manned live monitoring station, or may send data to both stations.

This application claims the benefit of U.S. Provisional Patent Application Ser. No. 61/854,734, filed Apr. 29, 2013, the disclosure of which is incorporated herein by reference.

### BACKGROUND OF THE INVENTION

This application relates generally to the field of remote monitoring, and in particular relates to remote monitoring of unmanned facilities, and even more particularly relates to remote monitoring of unmanned vehicle fuel dispensing stations.

Vehicle fuel dispensing or refueling stations, typically referred to as gas stations or fuel islands, number in the hundreds of thousands. Typical stations utilize employees, sometimes having the employees dispense the gasoline into the vehicles of individual customers, and at other times having one or more employees simply oversee the facility in the event there is an issue that needs to be addressed, the customers filling their own vehicles in a “self-service” manner and paying at the pump with a credit card. With the exception of fleet refueling stations, most fire marshal regulatory codes require the presence of an on-site employee to address emergencies, such as manually shutting off gas flow to the pumps or notifying emergency responders in the event of a fire.

It would be beneficial to the owners of the fuel islands to be able to operate under the self-service model without the requirement of maintaining an employee on-site. With an unmanned fuel island, systems must be in place 24 hours to monitor multiple aspects of the fuel island to determine if there are any issues of concern. It is an object of this invention to provide a fuel island redundant monitoring system for use with an unmanned fuel island that meets and exceeds regulatory safety requirements, the monitoring occurring at a geographically spaced location from the fuel island, with the monitoring system being redundant such that both live personnel and automatic machine monitoring can occur separately and simultaneously.

### SUMMARY OF THE INVENTION

A redundant monitoring system is provided for an unmanned fuel island, with the monitoring occurring remotely from the fuel island. Sensors of varying purpose are provided at the fuel island to transmit data to dual monitoring stations. One monitoring site is a live monitoring station manned by personnel. The other monitoring station is a data receiving station utilizing unmanned machines, e.g., computers. The unmanned data station is capable of transmitting information to the manned monitoring station, to local fuel island managers and/or to local emergency responders. The unmanned data station is also capable of transmitting commands or inquiries to control equipment at the fuel island. The manned monitoring station is capable of transmitting commands or inquiries to the unmanned data station and/or to control equipment at the fuel island. The manned monitoring station is also capable of transmitting information to local fuel island managers and/or to local emergency responders. Sensors may be dedicated to either the unmanned data station or the manned live monitoring station, or may send data to both stations. Examples of sensors include fire sensors, heat sensors, video surveillance cameras, spill detectors, smoke detectors, lead detectors, vapor detectors, etc., as well as sensors dedicated to particular equipment located at the fuel island to provide data on temperature, pressure, suction, gasket leaks, fuel inventory, preventive maintenance scheduling, etc.

In alternate terminology, the invention comprises An unmanned fuel island monitoring system comprising an unmanned fuel island adapted to deliver fuel to self-service consumers on demand; an unmanned data station geographically distant from said fuel island; a manned monitoring station geographically distant from said fuel island; a plurality of fuel island monitoring sensors incorporated in said fuel island, a first set of said monitoring sensors comprising machine-to-machine sensors transmitting data to said unmanned data station, and a second set of said monitoring sensors comprising live sensors transmitting data to said manned monitoring station; said unmanned data station transmitting information to said manned monitoring station. Further various embodiments of such a system with said manned monitoring station transmitting commands to said unmanned data station; said unmanned data station transmitting commands to said fuel island; said manned monitoring station transmitting commands to said fuel island; said unmanned data station transmitting information to local fuel island managers; said manned monitoring station transmitting information to local fuel island managers; said manned monitoring station transmitting information to emergency responders; said plurality of fuel island monitoring sensors further comprising a third set of said monitoring sensors comprising combination sensors transmitting data to both said unmanned data station and said manned monitoring station; said unmanned data station and said manned monitoring station transmitting commands to said fuel island; said unmanned data station and said manned monitoring station transmitting information to local fuel island managers and emergency responders; a communication system connecting said fuel island, said unmanned data station and said manned monitoring station; and/or wherein said communication system connects said unmanned data station to local fuel island managers and connects said manned monitoring station to said local fuel island managers and to emergency responders.

### BRIEF DESCRIPTION OF THE DRAWINGS

FIG. 1 is a schematic illustration of an exemplary embodiment of the system.

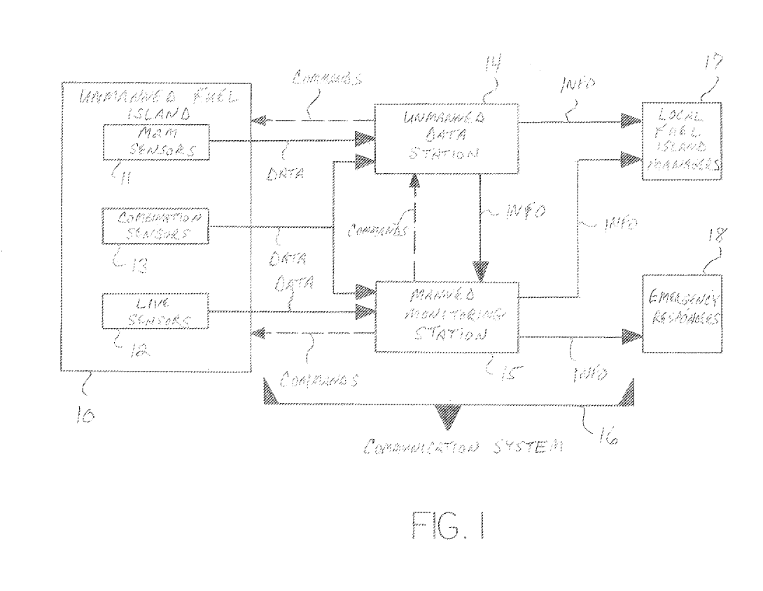

### DETAILED DESCRIPTION OF THE INVENTION

With reference to the drawings, the invention will be described in detail and with a non-limiting preferred embodiment. The invention in general is a fuel island redundant monitoring system wherein the monitoring of the fuel island is performed at one or more geographically distant sites from the fuel island, wherein the data is transmitted from sensors situated at the fuel island to an unmanned data station and a manned monitoring station, with communication between the sensors, the fuel island, the unmanned data station and the manned monitoring station, and further with local (relative to the fuel island) fuel island managers and emergency responders. The term “fuel island” as used herein refers a vehicle fuel dispensing or refueling facility where individuals bring in vehicles for self-service refueling, commonly referred to for example as a gas station. The fuel island may be open to public or may be utilized by particular members or companies having privileges at the fuel island, such as for example fleet refueling stations.

The unmanned fuel island 10 comprises one or more fuel pumps for self-service dispensing of fuel into vehicles when the vehicles are driven to the fuel island. Activation of the fuel pumps will require the use of an identity or member card, a credit card, a keypad code or the like. Many of the operational components or equipment of the unmanned fuel island 10 are standard, such as mechanical fuel pumps, electrical systems, lighting systems, etc. In addition to such standard equipment, the unmanned fuel island 10 is provided with a plurality of sensors, the sensors being capable of transmitting data signals through a communication system 16, such as via hard wire, radio frequency, WiFi, Internet connections, etc., to geographically remote data receiving stations—one such station being a manned monitoring station 15 with live personnel on-site responding to the received data and the other such station being an unmanned data station 14.

The sensors will be of varied type, one set of sensors 11 monitoring equipment or machine parameters and transmitting data through the communication system 16 to machines, i.e., computers or the like, in the unmanned data station 14, such sensors being referred to herein as M2M sensors 11. Such M2M sensors 11 are usually dedicated to machinery and equipment at the unmanned fuel island 10, such as for example fuel pumps, light fixtures, etc., and will monitor issues of concern relative to the equipment, such as for example temperature, pressure, suction, vibration, flow, gasket leaks, amount of use, bulb failures, etc. The data may be continuously or intermittently transmitted, or be transmitted only upon a negative occurrence when an issue needs to be addressed.

A second set of fuel island sensors are designated as live sensors 12 capable of transmitting data through the communication system 16 to the manned monitoring station 15. These live sensors 12 will monitor different issues of concern and may include for example fire sensors, heat sensors, video surveillance cameras, spill detectors, smoke detectors, lead detectors, vapor detectors, etc. As with the M2M sensors 11, the data may be continuously or intermittently transmitted, or be transmitted only upon a negative occurrence when an issue needs to be addressed immediately by the on-site personnel of the manned monitoring station 15.

Optionally, a third set of sensors, designated as combination sensors 13, may be provide at the fuel island in addition to or in place of certain M2M sensors 11 and/or live sensors 12. The combination sensors 13 transmit data from the fuel island 10 to both the manned monitoring station 15 and the unmanned data station 14, thereby providing a secondary redundance in addition to the primary redundancy of having an unmanned data station 14 and an manned monitoring station 15 remotely separated from the fuel island geographic location.

It is also contemplated that redundant sensors may be provided, such as for example having an M2M sensor 11 and a live sensor 12 that each detect smoke, or by providing sets of identical sensors, such as for example, two identical live sensors 12 for smoke detection, such that one such sensor may remain operational if fire were to disable the other smoke detector sensor.

The unmanned data station 14 and the manned monitoring station 15 may occupy separate locations or the same location, and the stations 14 and 15 may be in communication with multiple fuel islands 10. The stations 14 and 15 may be hundreds or thousands of miles from the fuel islands 10.

The unmanned data station 14 comprises equipment or machinery, such as computers or the like, to receive and analyze the data transmitted from the M2M sensors 11 and/or the combination sensors 13. In the event of situations that need to be addressed, or reports that are to be delivered on a periodic basis, etc., the unmanned data station 14 transmits information through the communication system 16 to the manned monitoring station 15, and/or to fuel island owners or managers 17, often geographically local to the fuel island 10, and/or to emergency responders 18 geographically local to the fuel island 10. The unmanned data station 14 may also transmit commands, which may include inquiries to sensors, back to the equipment at the fuel island.

For example, if an M2M sensor 12 detects that a fuel pump motor is overheating, the data is transmitted to the unmanned data station 14. The unmanned data station 14 may then transmit this information to the manned monitoring station 15 for validation and/or further action, and/or may automatically transmit a command to the fuel island to shut off the fuel pump motor. In the event of periodic reporting on equipment status at the fuel island 10, the unmanned data station 14 may transmit this information directly to the local fuel island managers 17.

The manned monitoring station 15 utilizes human personnel to analyze and respond appropriately to data received from the fuel island live sensors 12 and/or the combination sensors 13, and/or to information received directly from the unmanned data station 14. Preferably the personnel are trained in fuel island management and safety. The manned monitoring station 15 is capable of transmitting commands, including inquires, to the unmanned data station 14 in order to verify the information received from the manned data station or to seek secondary verification of the data received from the sensors incorporated in the fuel island 10, or to instruct the unmanned data station 14 to make inquiry of the dedicated M2M sensors 11. As with the unmanned data station 14, the manned monitoring station 15 is preferably capable of transmitting commands, including inquiries, to the fuel island 10, such that some issues may be verified by making inquiry of other live sensors 12, while others may be remotely rectified by the manned monitoring station 15, such as for example by remotely shutting off the fuel delivery pumps. The manned data station 15 is also capable of transmitting information to the local fuel island managers 17 if personnel need to be sent to the unmanned fuel island 10, and in the case of an emergency, such as visual evidence of a fire shown by a live sensor 13 or a large pressure drop in one of the fuel storage tanks being detected by an M2M sensor 12, such pressure drop potentially indicating a catastrophic failure with loss of large amounts of fuel, may also transmit this information to local emergency responders 18 for immediate response.

Other examples of the system response to situations:

The manned monitoring station 15 is alerted to a haze at the fuel island 10, by live sensors 12 or combination sensors 13, and/or by information transmitted from the unmanned data station 14 in response to data signals from M2M sensors 11 or combination sensors 13, and/or by direct contact from customers through voice or text communication, which may be part of the communication system 16. To determine whether this haze is a natural weather occurrence or the result of a fire, personnel in the manned monitoring station 15 review data from live sensors 12, such as a video camera, and also review information received from the unmanned data station 14, such as an abnormal temperature increase or detection of smoke. In the event a problem is verified, appropriate steps are taken, such as alerting the emergency responders 18, shutting off the fuel pumps, etc.

A driver leaves a fuel island 10 with the pump still inserted into the vehicle tank, breaking the hose and resulting in uncontrolled flow of fuel from the pump. M2M sensors 11 transmit the data signal to the unmanned data station 14 indicating this problem, and this information is immediately transmitted to the manned monitoring station 15. Visual confirmation is made by the live camera sensor 11 and the personnel verify that the unmanned data station 14 has transmitted a command to the fuel island 10 to shut off the fuel pump. If not, the manned monitoring station 15 transmits the command. The fuel island manager 17 is then alerted.

It is understood that equivalents and substitutions for certain elements set forth and described above may be obvious to those of skill in the art, and therefore the true scope and definition of the invention is to be as set forth in the following claims.

I claim:

1. An unmanned fuel island monitoring system comprising:
an unmanned fuel island adapted to deliver fuel to self-service consumers on demand;
an unmanned data station geographically distant from said fuel island;
a manned monitoring station geographically distant from said fuel island;
a plurality of fuel island monitoring sensors incorporated in said fuel island, a first set of said monitoring sensors comprising machine-to-machine sensors transmitting data to said unmanned data station, and a second set of said monitoring sensors comprising live sensors transmitting data to said manned monitoring station;
said unmanned data station transmitting information to said manned monitoring station.

2. The unmanned fuel island monitoring system of claim 1, said manned monitoring station transmitting commands to said unmanned data station.

3. The unmanned fuel island monitoring system of claim 1, said unmanned data station transmitting commands to said fuel island.

4. The unmanned fuel island monitoring system of claim 1, said manned monitoring station transmitting commands to said fuel island.

5. The unmanned fuel island monitoring system of claim 1, said unmanned data station transmitting information to local fuel island managers.

6. The unmanned fuel island monitoring system of claim 1, said manned monitoring station transmitting information to local fuel island managers.

7. The unmanned fuel island monitoring system of claim 1, said manned monitoring station transmitting information to emergency responders.

8. The unmanned fuel island monitoring system of claim 1, said plurality of fuel island monitoring sensors further comprising a third set of said monitoring sensors comprising combination sensors transmitting data to both said unmanned data station and said manned monitoring station.

9. The unmanned fuel island monitoring system of claim 1, said unmanned data station and said manned monitoring station transmitting commands to said fuel island.

10. The unmanned fuel island monitoring system of claim 1, said unmanned data station and said manned monitoring station transmitting information to local fuel island managers and emergency responders.

11. The unmanned fuel island monitoring system of claim 9, said unmanned data station and said manned monitoring station transmitting information to local fuel island managers and emergency responders.

12. The unmanned fuel island monitoring system of claim 2, said unmanned data station and said manned monitoring station transmitting commands to said fuel island.

13. The unmanned fuel island monitoring system of claim 2, said unmanned data station and said manned monitoring station transmitting information to local fuel island managers and emergency responders.

14. The unmanned fuel island monitoring system of claim 11, said unmanned data station and said manned monitoring station transmitting information to local fuel island managers and emergency responders.

15. The unmanned fuel island monitoring system of claim 1, further comprising a communication system connecting said fuel island, said unmanned data station and said manned monitoring station.

16. The unmanned fuel island monitoring system of claim 15, wherein said communication system connects said unmanned data station to local fuel island managers and connects said manned monitoring station to said local fuel island managers and to emergency responders.

17. An unmanned fuel island monitoring system comprising:
an unmanned fuel island delivering fuel to self-service consumers on demand;
an unmanned data station geographically distant from said fuel island, said unmanned data station transmitting commands to said fuel island;
a manned monitoring station geographically distant from said fuel island, said manned monitoring station transmitting commands to said unmanned data station and to said fuel island;
a plurality of fuel island monitoring sensors incorporated in said fuel island, a first set of said monitoring sensors comprising machine-to-machine sensors transmitting data to said unmanned data station, and a second set of said monitoring sensors comprising live sensors transmitting data to said manned monitoring station;
said unmanned data station transmitting information to said manned monitoring station.

18. The unmanned fuel island monitoring system of claim 17, said plurality of fuel island monitoring sensors further comprising a third set of said monitoring sensors comprising combination sensors transmitting data to both said unmanned data station and said manned monitoring station.

19. The unmanned fuel island monitoring system of claim 17, further comprising a communication system connecting said fuel island, said unmanned data station and said manned monitoring station.

20. The unmanned fuel island monitoring system of claim 19, wherein said communication system connects said unmanned data station to local fuel island managers and connects said manned monitoring station to said local fuel island managers and to emergency responders.
